(19) United States
(12) Patent Application Publication
(10) Pub. No.: US 2004/0141810 A1
(43) Pub. Date: Jul. 22, 2004

(54) Soil desalinator

(76) Inventor: Clark Lysne, Wetaskiwin (CA)

Correspondence Address: EDWARD YOO C/O BENNETT JONES, 1000 ATCO CENTRE, 10035 - 105 STREET, EDMONTON, ALBERTA, AB, T5J3T2, CA

(21) Appl. No.: 10/248,417

(22) Filed: Jan. 17, 2003

(51) Int. Cl. C05C 1/00; E02B 11/00

(52) U.S. Cl. 405/36; 71/27

(57) ABSTRACT

The present invention is directed to an apparatus for desalinating soil. In accordance with the teachings there is disclosed an apparatus comprising a frame, a distribution pipe and an associated evaporating cloth. In one embodiment water is removed from the ground by way of a foot valve and a pump. The water is transported to the distribution pipe by a riser pipe. The distribution pipe transfers the water to the vertically orientated evaporating cloth upon which the water evaporates leaving crystalline salt that can then be collected and removed. The flow of water to the cloth may be regulated by a switch mechanism or valve mechanism that is triggered by the water levels on the evaporating cloth.

### BACKGROUND OF THE INVENTION

The present invention relates to an apparatus for desalinating soil.

Elevated soil salt levels are a significant global agricultural and environmental concern and can lead to problems such as inhibited plant growth and reduced crop yield. Elevated salt levels are caused by a number of different factors including; unusually high natural mineral levels, pollution from industrial operations, soil contamination from oil and gas removal and irrigation with water containing salts.

Current solutions to this problem include the addition of chemicals to the soil, the development of salt tolerant strains of plants and the physical removal and replacement of the affected soil. These options can be environmentally detrimental and are all relatively expensive and labour intensive. Given that a significant portion of the global agricultural community operates under impoverished conditions, particularly in developing countries, there is a need in the art for simple and inexpensive solution to this problem.

There are well known varying cultural methods of desalinating salt water for the purpose of obtaining fresh drinkable water. In the prior art, one approach to desalinating water teaches the use of an apparatus that applies atomized salt water in a blown warm air environment to an evaporating cloth or net (CA patent 2,279,884). However, the prior art involves the use of complex and expensive equipment and is directed to removing salt from water sources and not salt from soil. Therefore there is a need in the art for a simple and inexpensive apparatus for the desalination of soil.

### SUMMARY OF THE INVENTION

The present invention is directed to an apparatus for the desalination of soil.

Accordingly, in one aspect of the invention, the invention comprises an apparatus comprising:

(a) a frame having vertical supports and a horizontal cross beam;

(b) at least one evaporating cloth attached to the cross beam;

(c) a distribution pipe for receiving ground water and depositing it evenly onto the evaporating cloth, the distribution pipe being attached to the frame in a position adjacent to the evaporating cloth;

(d) means for drawing water from the soil to the distribution pipe;

(e) means to regulate the volume of water deposited onto the evaporating cloth; and

(f) a container to hold the crystallized salt that detaches from the evaporating cloth.

In another aspect of the invention, the invention comprises an apparatus comprising:

(a) a frame having vertical supports and a horizontal cross beam;

(b) at least one vertically orientated evaporating cloth attached to the cross beam, the cross beam having a first end and a second end, wherein the first end of the cross beam is hingedly attached to the vertical supports and the second end is suspended from the vertical supports by an extendible member such that the cross beam is moveable between an upper horizontal position and a lower angled position;

(c) a mechanical switch mechanism moveable between a first on position and a second off position, the switch being attached to the second end of the cross beam such that when the cross beam is in its upper horizontal position horizontal the switch is in its on position and when the cross beam is in its lower angled position the switch is in its off position;

(d) a distribution pipe for receiving ground water and depositing it evenly onto the evaporating cloth, the distribution pipe being attached to the frame in a position adjacent to the evaporating cloth;

(e) a foot valve protruding below the water table;

(f) a pump connected to the foot valve, the pump's activity being controlled by the switch mechanism;

(g) a riser pipe for transporting the water from the pump to the distribution pipe; and

(h) a container to hold the crystallized salt that detaches from the evaporating cloth.

In another aspect of the invention, the invention comprises an apparatus comprising:

(a) a frame having vertical supports and a horizontal cross beam;

(b) at least one vertically orientated evaporating cloth attached to the cross beam, the cross beam having a first end and a second end, wherein the first end of the cross beam is hingedly attached to the vertical supports and the second end is suspended from the vertical supports by an extendible member such that the cross beam is moveable between an upper horizontal position and a lower angled position;

(c) a mechanical valve mechanism moveable between a first open position and a second closed position, the valve being attached to the second end of the cross beam such that when the cross beam is in its upper horizontal position the valve is in its open position and when the cross beam is in its lower angled position the valve is in its closed position;

(d) a distribution pipe for receiving ground water and depositing it evenly onto the evaporating cloth, the distribution pipe being attached to the frame in a position adjacent to the evaporating cloth;

(e) a foot valve protruding below the water table;

(f) a pump connected to the foot valve;

(g) a riser pipe for transporting the water from the pump to the reservoir;

(h) a reservoir for receiving water from the riser pipe water and transferring it to the distribution pipe, the reservoir being mounted on the frame adjacent to the distribution pipe and having an overflow pipe that carries water back to the foot valve if the reservoir becomes too full and having an outlet to the distribution pipe that is attached to the valve mechanism; and

(i) a container to hold the crystallized salt that detaches from the evaporating cloth.

In another aspect of the invention, the invention comprises an apparatus comprising:

(j) an enclosed container;

(k) an elongated hollow tube with one curved end, wherein the straight end of the tube is inserted into the ground in a substantially vertical orientation and the curved end is inserted into the enclosed container such that the orientation of the opening at the curved end is parallel with the ground; and

(l) an evaporating cloth stuffed into the cavity of the entire length of the hollow tube and protruding for a distance from the opening at each end of the tube.

In one embodiment, the pump may be a solar powered electric pump or a wind driven pump. In another embodiment, the extendible member may be a coil spring.

### BRIEF DESCRIPTION OF DRAWINGS

The invention will now be described by way of an exemplary embodiment with reference to the accompanying simplified, diagrammatic, not to scale drawings. In the drawings:

FIG. 1 is a side view of one embodiment of the invention.

FIG. 2 is side view of another embodiment.

FIG. 3 is a schematic top view of trench and ditch systems that can be used in conjunction with the apparatus.

FIG. 4 is a schematic top view of trench and ditch systems that can be used in conjunction with the apparatus.

FIG. 5 is a side view of one embodiment of the invention.

### DETAILED DESCRIPTION

The present invention is directed to an apparatus for the desalination of soil.

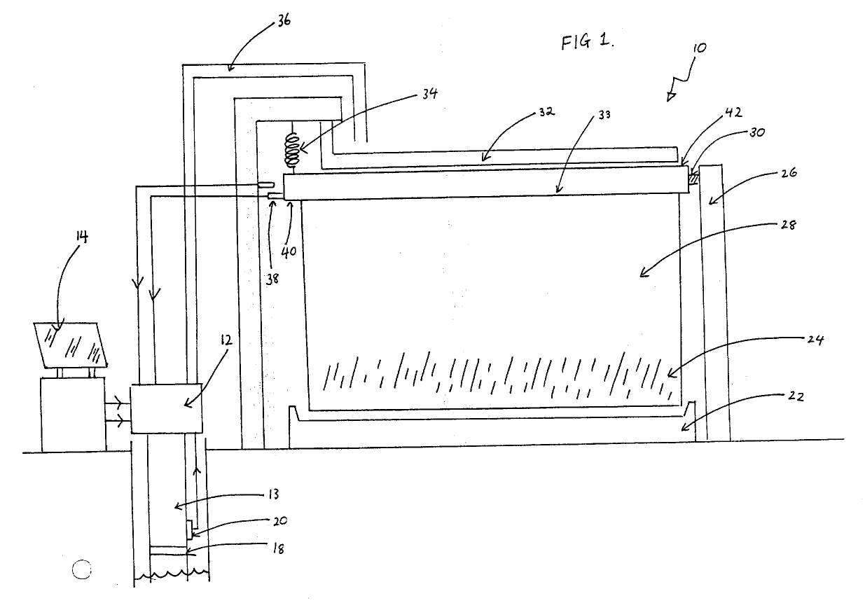

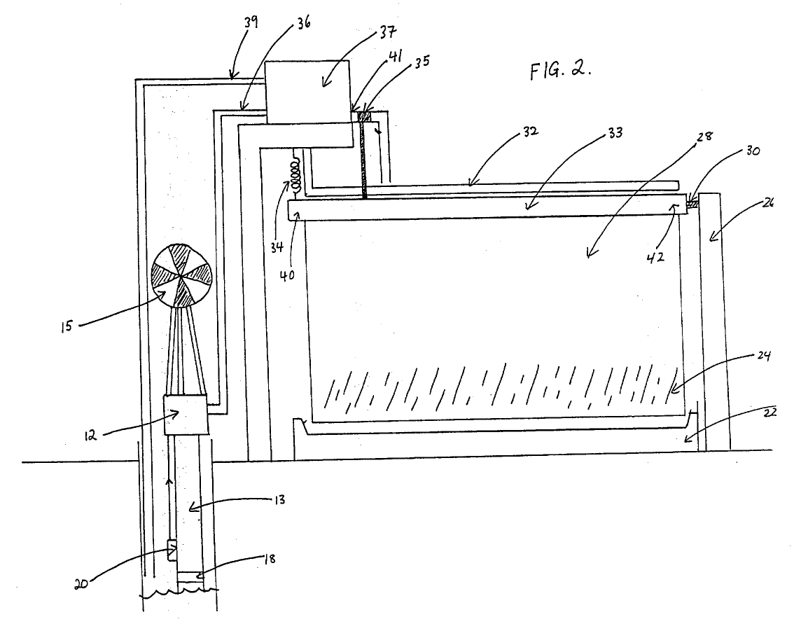

The apparatus (10) according to the Figures is comprised of a frame having vertical support members (26) and a horizontal cross beam (33), the cross beam (33) having a first end (42) and a second end (40). The apparatus (10) has at least one evaporating cloth (28) that is attached to the cross beam (33). Immediately above the evaporating cloth (28) and the cross beam (33) is the distribution pipe (32) which is physically configured to deposit water evenly onto the cloth (28). As shown in FIG. 1, the distribution pipe (32) is horizontally orientated. In one embodiment the distribution pipe is mounted to the frame at one end as shown in FIGS. 1 and 2, however, it can also be attached to the frame at each end for increased support. As depicted in FIG. 1, the evaporating cloth (28) will hang in a substantially vertical orientation, however it should be understood that the evaporating cloth (28) may also be suspended in other orientations without impairing its functionality. In a preferred embodiment, the cloth (28) will be orientated in a north-south manner to maximize the sunlight received by each side of the evaporating cloth (28). Multiple distribution pipes and evaporating cloths may be used depending on the volume of groundwater available.

The evaporating cloth (28) may be made from any porous material which absorbs water (or at least which is not hydrophobic) and which presents a relatively large surface area for evaporation.

As depicted in FIG. 1, there is provided a means for drawing water from the soil to the distribution pipe (32). As shown in FIG. 1, in one embodiment the means comprises a foot valve (13) protruding below the water table, an associated pump (12) and a riser pipe (36) for carrying the water from the pump (12) to the distribution pipe (32). If a foot valve (13) is used a filter (18) may also be used to prevent solid particulate matter from clogging the pump (12) and the distribution pipe (32). In a preferred embodiment a low volume switch (20) may be used in conjunction with the foot valve (13) and pump (12) to disengage the pump when the water levels drop to a certain level in the foot valve. The pump (12) may be a solar powered electric pump (14) as shown in FIG. 1 or a wind powered pump (15) as shown in FIG. 2, or such other type of pump as is suitable for the means and as would be selected by those skilled in the art. Such suggestions for the means to draw water to the distribution pipe are not intended to be limiting of the invention claimed herein and in developing countries, the means for drawing water from the ground to the distribution pipe (32) may be as simple as an individual hand bailing a hole dug in the ground.

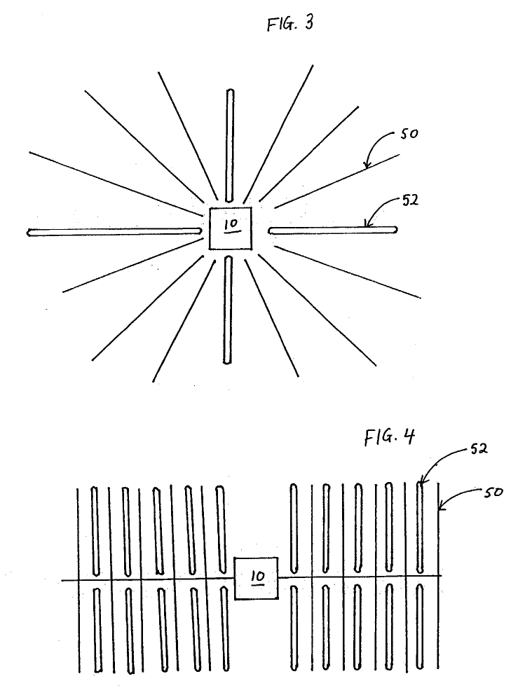

Varying devices and techniques may be used to enhance collection at the foot valve (13) including the use of radiating trenches (50) and weeping tile and the use of perforated plastic laid over the surrounding area to keep moisture in the ground but facilitating the entry of rain water. As depicted in FIGS. 3 and 4, proximate ditches (52) may also be created which can be flooded with clean water to promote water flow through the soil to the trenches (50) and ultimately to the foot valve (13).

The apparatus (10) also requires a means to regulate the flow of the water transmitted to the evaporating cloth (28). If too much water is released onto the cloth it will not evaporate and will simply run down the cloth and into the salt container (22). In a preferred embodiment a mechanical switch mechanism (38) is attached to the second end of the cross beam (40). When closed the switch completes a circuit and the pump (12) is activated. When the switch (38) opens the circuit is broken and the pump (12) is turned off. As depicted in FIG. 1, in one embodiment the first end of the cross beam (42) is hingedly attached (30) to the frame (26) and the second end (40) is suspended by an extendible member (34). When the evaporating cloth (28) is wetted it becomes heavier and the extendible member (34) stretches lowering the second end (40) to a lower full position. In one preferred embodiment the extendible member (34) is a coil spring. In this lower position the switch (38) is opened, the circuit is broken and the pump (12) is turned off. As the distribution pipe (32) empties and as the evaporating cloth (28) dries it becomes lighter and the extendible member (34) retracts moving the second of the cross beam (40) to its substantially horizontal upper empty position. In this position the switch (38) is shut, the circuit is closed and the pump (12) is activated causing more water to enter the distribution pipe (32). Other types of volume regulators suitable for the means and as would be selected by those skilled in the art may also be used to regulate the flow of water from the riser pipe (36) to the distribution pipe (32).

As shown in FIG. 2, in a further embodiment of the apparatus (10), a reservoir (37) may be attached to the frame (26) adjacent to the distribution pipe (32). The riser pipe (36) delivers water to the reservoir (37) from the pump (12) and foot valve (13). The reservoir (37) has an associated overflow pipe (39) which carries water back to the foot valve (13) if the reservoir becomes too full. The reservoir has an outlet (41) that feeds water into the distribution pipe (32). In a preferred embodiment a mechanical valve mechanism (35) moveable between a first open position and a second closed position, is attached to the reservoir outlet (41) and the second end of the cross beam (40). When the valve (35) is opened water flows from the reservoir (37) via the outlet (41) to the distribution pipe (32). When the valve (35) closes the flow of water from the reservoir (37) to the distribution pipe (32) is stopped. As shown in FIG. 2, in one embodiment the first end of the cross beam (42) is hingedly attached (30) to the vertical support members (26) and the second end (40) is suspended by an extendible member (34). When the evaporating cloth (28) is wetted it grows heavier and the extendible member (34) stretches lowering the second end (40) to a lower full position. The extendible member may be a coil spring. The valve (35) is moved to its closed position and the flow of water from the reservoir (37) to the distribution pipe (32) is stopped. As the distribution pipe (32) empties and as the evaporating cloth (28) dries and becomes lighter the extendible member (34) retracts and the second end of the cross beam (40) moves to its substantially horizontal upper empty position. The valve (35) is moved to its open position causing water to enter the distribution pipe (32) from the reservoir (37). Other types of volume regulators suitable for the means and as would be selected by those skilled in the art may also be used to regulate the flow of water from the reservoir (37) to the distribution pipe (32).

The apparatus (10) may also be fitted with a roof or rain guard to prevent rain from entering the distribution pipe (32), striking the evaporating cloths (28) or getting into the salt container (22).

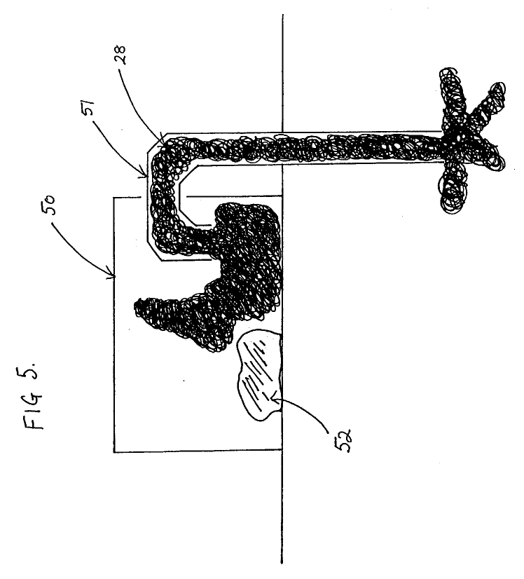

As shown in FIG. 5, in another simple embodiment the apparatus is comprised of a hollow tube (51) having one end inserted into the ground and having the other curved end inserted into an enclosed container (50). The cavity of the hollow tube (51) is stuffed with an evaporating cloth (28) such that the cloth protrudes from each end of the tube (51). The natural capillary action of the water moving from the moist ground to the evaporating cloth draws moisture up the tube (51). As the moisture moves up the receptacle (51), it evaporates on the cloth (28) and the crystallized salt is collected in the container (50). A weight (52) such as a rock may be used to weigh the container (50) down. This embodiment is suitable for desalinating relatively small ground areas with limited moisture, although multiple units could be used if necessary. This embodiment is particularly useful for city gardens adjacent to salty freeways. Perforated plastic or straw may be placed on the ground around the apparatus to promote moisture retention in the soil.

The operation of the apparatus (10) will now be described with reference to FIG. 1. Ground water containing dissolved salts enters the foot valve (13). This water is drawn into the foot valve (13) through a filter (18) by an associated pump mechanism (12). The water is transported from the pump (12) to the distribution pipe (32) by a riser pipe (36). Once in the distribution pipe (32), the water is uniformly deposited to the adjacent evaporating cloth (28). The water moves down the cloth (28) and is dried by the sun and wind. The dissolved salts crystallize and the solid salt (24) can be removed and placed in an adjacent salt container (22). Some salts can be removed physically from the cloth, others will simply flake off into the container and some will require flushing from the cloth, the salt-laden waste water being caught in the container (22) where it will evaporate leaving solid salt which can be disposed of in an appropriate manner. In the embodiment depicted in FIG. 1, the flow of the water to the distribution pipe (32) is regulated by a switch mechanism (38) that shuts the pump (12) off when the evaporating cloth (32) is wet and weighted down, however as shown in FIG. 2 the flow of the water may also be regulated by means of a reservoir (37) and associated valve mechanism (35).

As will be apparent to those skilled in the art, various modifications, adaptations and variations of the foregoing specific disclosure can be made without departing from the scope of the invention claimed herein. The various features and elements of the described invention may be combined in a manner different from the combinations described or claimed herein, without departing from the scope of the invention.

1. An apparatus for desalinating soil, said apparatus comprising:
(a) a frame having vertical supports and a horizontal cross beam;
(b) at least one evaporating cloth attached to the cross beam;
(c) a distribution pipe for receiving ground water and depositing it evenly onto the evaporating cloth, the distribution pipe being attached to the frame in a position adjacent to the evaporating cloth;
(d) means for drawing water from the soil to the distribution pipe;
(e) means to regulate the volume of water deposited onto the evaporating cloth; and
(f) a container to hold the crystallized salt that detaches from the evaporating cloth.

2. The apparatus of claim 1 wherein the means for drawing water from the soil to the distribution pipe comprises a foot valve protruding below the water table, a pump connected to the foot valve and a riser pipe for carrying water from the pump to the distribution pipe.

3. The apparatus of claim 2 further comprising a reservoir between the riser pipe and the distribution pipe, the reservoir being attached to the frame in a position adjacent to the distribution pipe and having an outlet to the distribution pipe and having an overflow pipe that carries water back to the foot valve if the reservoir becomes too full.

4. The apparatus of claim 2 wherein the means to regulate the volume of water deposited onto the evaporating cloth is comprised of switch mechanism associated with the evaporating cloth which deactivates the pump when the cloth is wet and activates the pump when the cloth is dry.

5. The apparatus of claim 3 wherein the means to regulate the volume of water deposited to the evaporating cloth is comprised of a valve mechanism connected to the reservoir outlet that opens allowing water to flow into the distribution pipe when the cloth is dry and which closes stopping the water flow when the cloth is wet.

6. The apparatus of claim 2 wherein the pump is a solar powered electrical pump.

7. The apparatus of claim 2 wherein the pump is a wind powered pump.

8. An apparatus for desalinating soil, said apparatus comprising:
(a) a frame having vertical supports and a horizontal cross beam;
(b) at least one vertically orientated evaporating cloth attached to the cross beam, the cross beam having a first end and a second end, wherein the first end of the cross beam is hingedly attached to the vertical supports and the second end is suspended from the vertical supports by an extendible member such that the cross beam is moveable between an upper horizontal position and a lower angled position;
(c) a switch mechanism moveable between a first on position and a second off position, the switch being attached to the second end of the cross beam such that when the cross beam is in its upper position horizontal the switch is in its on position and when the cross beam is in its lower angled position the switch is in its off position;
(d) a distribution pipe for receiving ground water and depositing it evenly onto the evaporating cloth, the distribution pipe being attached to the frame in a position adjacent to the evaporating cloth;
(e) a foot valve protruding below the water table;
(f) a pump connected to the foot valve, the pump's activity being controlled by the switch mechanism;
(g) a riser pipe for transporting the water from the pump to the distribution pipe; and
(h) a container to hold the crystallized salt that detaches from the evaporating cloth.

9. The apparatus of claim 8 wherein the pump is a solar powered electrical pump.

10. The apparatus of claim 8 wherein the pump is a wind powered pump.

11. The apparatus of claim 8 wherein the extendible member is a coil spring.

12. An apparatus for desalinating soil, said apparatus comprising:
(a) a frame having vertical supports and a horizontal cross beam;
(b) at least one vertically orientated evaporating cloth attached to the cross beam, the cross beam having a first end and a second end, wherein the first end of the cross beam is hingedly attached to the vertical supports and the second end is suspended from the vertical supports by an extendible member such that the cross beam is moveable between an upper horizontal position and a lower angled position;
(c) a valve mechanism moveable between a first open position and a second closed position, the switch being attached to the second end of the cross beam such that when the cross beam is in its upper horizontal position the valve is in its open position and when the cross beam is in its lower angled position the valve is in its closed position;
(d) a distribution pipe for receiving ground water and depositing it evenly onto the evaporating cloth, the distribution pipe being attached to the frame in a position adjacent to the evaporating cloth;
(e) a foot valve protruding below the water table;
(f) a pump connected to the foot valve;
(g) a riser pipe for transporting the water from the pump to the reservoir;
(h) a reservoir for receiving water from the riser pipe water and transferring it to the distribution pipe, the reservoir being mounted on the frame adjacent to the distribution pipe and having an overflow pipe that carries water back to the foot valve if the reservoir becomes too full and having an outlet to the distribution pipe that is attached to the valve mechanism; and
(i) a container to hold the crystallized salt that detaches from the evaporating cloth.

13. The apparatus of claim 12 wherein the pump is a solar powered electrical pump.

14. The apparatus of claim 12 wherein the pump is a wind powered pump.

15. The apparatus of claim 12 wherein the extendible member is a coil spring.

16. An apparatus for desalinating soil, said apparatus comprising:
(a) an enclosed container;
(b) an elongated hollow tube with one curved end, having the straight end inserted into the ground in a substantially vertical orientation and having the curved end inserted into the enclosed container such that the orientation of the opening at the curved end is parallel with the ground; and
(c) an evaporating cloth stuffed into the cavity of the entire length of the hollow tube and protruding for a distance from the opening at each end of the tube.
